(19) United States
(12) Patent Application Publication
(10) Pub. No.: US 2023/0156117 A1
(43) Pub. Date: May 18, 2023

(54) METHOD FOR OPERATING A MANAGEMENT PROGRAM

(71) Applicant: Robert Bosch GmbH, Stuttgart (DE)

(72) Inventors: Andreas Heyl, Weil Der Stadt (DE); Markus Schweizer, Vaihingen/Enz (DE)

(21) Appl. No.: 18/054,705

(22) Filed: Nov. 11, 2022

(30) Foreign Application Priority Data
Nov. 16, 2021 (DE) 10 2021 212 861.0

(51) Int. Cl. H04M 1/72463; B60W 50/08

(52) U.S. Cl. CPC H04M 1/72463; B60W 50/08

(57) ABSTRACT

A method for operating a management program provided to manage at least one intervention from at least one application program to at least one component of the motor vehicle. In the method, when establishing the extent of the at least one intervention, information describing a driving mode of the vehicle is taken into account.

### CROSS REFERENCE

The present application claims the benefit under 35 U.S.C. § 119 of German Patent Application No. DE 10 2021 212 861.0 filed on Nov. 16, 2021, which is expressly incorporated herein by reference in its entirety.

### FIELD

The present invention relates to a method for operating a management program and a system for carrying out the method.

### BACKGROUND INFORMATION

The above-described management program is provided to manage interventions from at least one application program, in particular an application program for mobile devices or mobile operating systems. Application programs or application software are/is used in different areas. In this case, application programs that are configured for use in mobile devices, such as for example smartphones or tablets, or for mobile operating systems are considered in particular. Such an application program is, in short, also referred to as an app. Such apps are also used in connection with vehicles, even in the case of autonomous, i.e., automatedly driving, vehicles.

In this way, functions or driver assistance functions may be subsequently introduced into the vehicle via apps that represent rechargeable functions. This is carried out even if the vehicle is already in the field.

In this case, the apps may either be subsequently recharged and carried out in the vehicle, for example in a vehicle control unit, or outside of the vehicle, for example in a smartphone or in a cloud that is connected to the vehicle.

One interesting possibility presents itself when the conventional app concept from the CE (consumer electronics) world (smartphones, tablets) is transferred to the motor vehicle, i.e., making it possible for any developer to write and offer apps. This may give rise to completely new application possibilities, as is conventional in the CE world, also in the automotive field, in particular if the apps implement driver assistance functions. For this purpose, the rechargeable functions, however, need access to actuators and may carry out actions that are potentially security-relevant. It is thus necessary to take safety requirements into account.

It is to be noted that apps transfer and process interventions, in particular external interventions, for example from a web browser or a cloud, which in many cases originate from unsecured environments, such as for example development processes, hardware, software, and do not meet any safety standards. They thus do not meet ASIL-X, but only QM, i.e., as in the case of comfort consumers. It is therefore necessary to delimit their intervention strength. Thus, the argument may be made that the physical effect of erroneous interventions also always remains controllable for the driver, as described in German Patent Application No. DE 10 2014 209 489 A1.

German Patent Application No. DE 10 2014 209 489 A1 describes a coupling device for coupling a software component in a motor vehicle that makes it possible to securely integrate the software component into a motor vehicle. The software component is configured to transmit a positioning request to a control system of a motor vehicle. The coupling device includes a monitoring unit that is configured to carry out an evaluation for each positioning request, as to whether its implementation would transfer the motor vehicle into a dangerous state. The coupling device is further configured to transmit, as a function of this evaluation, a positioning request, which is monitored according to the positioning request, to an implementation unit, the implementation unit being configured to activate an actuator.

With the aid of the limitation described in the above-mentioned publication, the usability of these apps is limited, however. An expansion of the limits would provide the user with more advantages, more comfort, etc.

This aspect is also described in German Patent Application No. DE 10 2014 209 489 A1. However, in the case of the method provided in this publication, the expansion of the limits as a function of the driving situation is only described for vehicles, in which the driver is permanently responsible for driving the vehicle and is able to intervene any time in a correcting manner.

For higher levels of automation (L2+, L3, L4), an automated driving system (ADS) takes over the driving of the vehicle. In this case, ADS takes over all tasks required for driving and monitors the driving surroundings. The controllability thus also changes; in particular, an ADS is in most cases better at controlling, compensating for or mitigating erroneous activations or requirements that are not appropriate in the situation. An ADS is thus, for example, able to respond more quickly to an arising dangerous situation. An expansion of the characteristics for the limitation of the external intervention is thus possible.

### SUMMARY

A method, as well as a system are provided according to the present invention. Specific embodiments result from the disclosure herein.

The method according to the present invention is used to operate a management program that is provided to manage at least one intervention from at least one application program in a motor vehicle in at least one component of the motor vehicle. When establishing the extent of the at least one intervention, information describing a driving mode of the vehicle is taken into account. When establishing the extent of the intervention, a driving mode of the vehicle, in particular the instantaneous driving mode of the vehicle, is thus taken into account. This may mean that a signal carrying the information that describes a driving mode or this information is taken into account when establishing the extent of the intervention.

“Managing an intervention” means that the management program is configured to correspondingly forward or process an intervention, which is potentially externally requested, so that this intervention may be carried out.

Components of the motor vehicle may be hardware and/or software components of the motor vehicle. Furthermore, components may be considered with regard to them carrying out or implementing certain functions in the motor vehicle.

The extent of an intervention determines the scope of this intervention, i.e., to what extent which components may be intervened in or accessed. It may thus be established, which components may be accessed at all by which application program and in what scope this access is permitted.

The present invention thus provides, in one example embodiment, a method in which, as a function of the driving mode of a vehicle, the limitations of the interventions are expanded or limited externally, for example via a web browser or a cloud, through rechargeable functions, i.e., apps. This results in the advantage that these functions may also carry out “stronger” interventions depending on the mode and may thus potentially be more useful, without diminishing the security of the system overall.

Further advantages and embodiments of the present invention are derived from the description and the figures.

It is understood that the above-mentioned features and the features to be elucidated below are usable not only in the given combination, but also in other combinations or alone without departing from the scope of the present invention.

### BRIEF DESCRIPTION OF THE DRAWINGS

FIG. 1 shows a flowchart of one specific embodiment of the method according to the present invention.

FIG. 2 shows in a schematic illustration a motor vehicle including a system for carrying out the method, according to an example embodiment of the present invention.

### DETAILED DESCRIPTION OF EXAMPLE EMBODIMENTS

The present invention is illustrated schematically in the figures on the basis of specific embodiments and is described in greater detail in the following with reference to the figures.

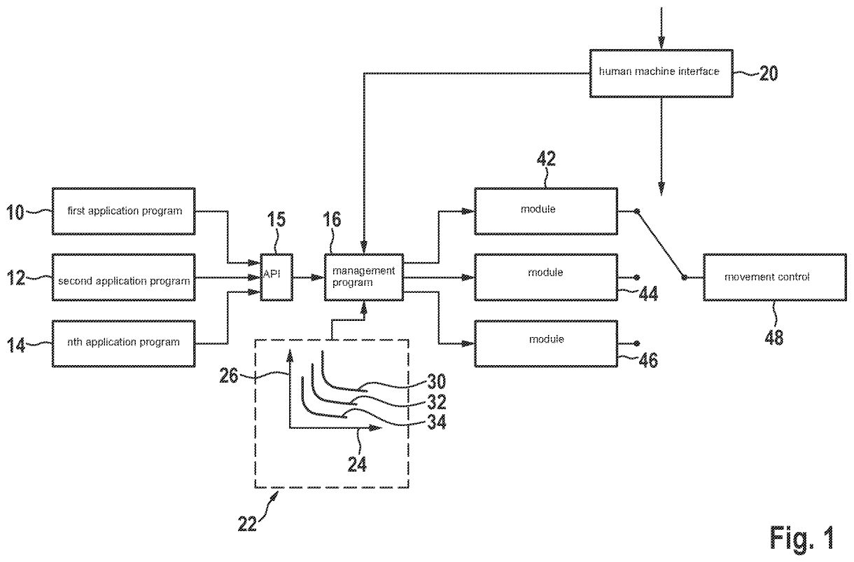

FIG. 1 describes a possible sequence of the method presented above. The illustration shows a first application program App_1 10, a second application program App_2 12, and an nth application program App_n 14. These application programs 10, 12, 14 provide input signals for a management program 16 that receives these via an application interface App API 15. Further input signals are provided by a human machine interface 20, in which an entry is input by a driver and in which information with regard to a selection of an AD module (CCU) is input. CCU is the so-called connectivity control unit, i.e., the communication module of the vehicle for external communication, for example LTE, 5G, Wi-Fi, etc.

Management program 16 takes into account the characteristics from a safety features map, on which abscissa 24 p2 and its ordinate 26 p1 are plotted. p1 and p2 are parameters, for example velocity and the maximally permitted brake intervention or steering intervention. In this map 22, a first characteristic 30 is plotted for L4, a second characteristic 32 is plotted for L3, and a third characteristic 34 is plotted for L2. L2 through L4 indicate different driving modes that are elucidated in greater detail in the following.

Application interface App API 16 provides output signals for L2 SW 42, L3 SW 44, and L4 SW 46. L2 SW 42 together with an output signal from human machine interface 20 provides information to a movement control 48.

Modules 42 through 46 are functions for automated driving, for example automated emergency braking (AEB) including in particular radar-based object recognition and brake intervention (L2) or the various system elements for fully automated driving (L4), such as perception, surroundings model generation, behavior and trajectory planning.

Depending on the driving mode and potentially on external information, a different characteristic is selected for the intervention, here for example L3.x for L3, whose compliance is ensured by application interface App API 16. The app interventions (“App_x”) may take place from within the vehicle system, for example a control unit or a software, or from outside, for example a cloud, a web browser, a smartphone, etc.

With regard to the individual driving modes, the following is carried out:

The driver controls the vehicle using driver assistance either in the longitudinal direction or in the transversal direction (L1), as is also described in publication DE 10 2014 209 489 A1.

The ADS controls, the driver observes the vehicle with hands on the steering wheel (L2).

The ADS controls, the driver observes the vehicle without hands on the steering wheel (L2 hands-free).

The ADS controls, the driver does not observe the vehicle, but must be able to take control within a certain period of time (L3).

The ADS controls, the driver does not have to observe nor be able to intervene (L4).

The limitations for ensuring the controllability on the system level, i.e., ADS, or on the vehicle level, namely the driver, may refer to the following interventions:
actuator-specific interventions, for example engine, brakes, steering, but also lights, seat adjustment, active suspension, etc.,
movement-specific interventions, for example longitudinal, lateral, vertical.

For the adjustment of the limitations, the following is carried out:
switching over the limitation characteristics depending on the driving mode and externally determined criticality of the instantaneous situation,
run-up phase/drop phase during the transition between the modes or characteristics to avoid abrupt changes in control, error messages and/or a termination of the external intervention due to error detection, controlled by management program 16 and/or supported by apps 10, 12, 14 by providing appropriate transition characteristics,
optional warning of the driver, for example acoustically, visually and/or haptically with the aid of a human machine interface, when adjusting the limitations.

The management of the limitations takes place in management program 16.

Management program 16, which may be regarded as a part of API 15, of the app interventions should report back the instantaneously pertinent limitations or also, prognostically, the future limitations to apps 10, 12, 14, so that same are able to respond to them accordingly in terms of regulation.

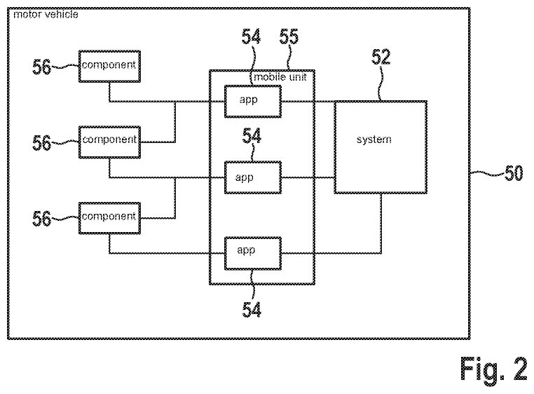

FIG. 2 shows in a schematic illustration and heavily simplified form a motor vehicle that is denoted overall by reference numeral 50. A system 52 for carrying out the method presented here is provided in this motor vehicle 50. This system 52 manages a series of apps 54 that in turn have access to components 56 of motor vehicle 50 or manage accesses to these components 56 and are stored in a mobile unit 55. Information describing a driving mode of vehicle 50 is taken into account to establish the extent of the accesses of individual apps 54 to individual components 56. It is to be noted that apps 54 may also be regarded as components 56 of motor vehicle 50, which may be accessed.

What is claimed is:

1. A method for operating a management program that is provided to manage at least one intervention from at least one application program into at least one component of the motor vehicle, the method comprising:
establishing an extent of the at least one intervention, wherein information describing a driving mode of the vehicle is taken into account.

2. The method as recited in claim 1, wherein the at least one intervention takes place internally.

3. The method as recited in claim 1, wherein the at least one intervention takes place externally.

4. The method as recited in claim 1, wherein the application program is configured to implement a driver assistance system.

5. The method as recited in claim 1, wherein the extent of the at least one intervention is limited.

6. The method as recited in claim 1, wherein the extent of the intervention is expanded.

7. The method as recited in claim 1, wherein characteristics, which are assigned to different driving modes, are accessed.

8. The method as recited in claim 7, wherein a transition is carried out between different characteristics.

9. The method as recited in claim 8, wherein during the transition between the different characteristics, a run-up phase and a drop phase are taken into account.

10. A system for operating an application program, the system configured to manage at least one intervention from the application program into at least one component of the motor vehicle, the system configured to:
establish an extent of the at least one intervention, wherein information describing a driving mode of the vehicle is taken into account.
